(19) United States
(12) Patent Application Publication
(10) Pub. No.: US 2008/0163109 A1
(43) Pub. Date: Jul. 3, 2008

(54) USER CONFIGURABLE ACTION BUTTON

(76) Inventors: SANTHANAM SRIVATSAN, Bangalore (IN); Aurobinda Pradhan, Bangalore (IN); Ramya Kukehalli Subramanya, Bangalore (IN)

Correspondence Address: SAP AG, 3410 HILLVIEW AVENUE, PALO ALTO, CA, 94304, US

(21) Appl. No.: 11/617,783

(22) Filed: Dec. 29, 2006

(51) Int. Cl. G06F 3/048

(52) U.S. Cl. 715/810

(57) ABSTRACT

An embodiment of the invention is directed to a method comprising associating at least one action with at least one of a plurality of action buttons; customizing associations of the associated actions; and including the customized associated actions, corresponding to one of the plurality of action buttons, in an expandable action menu when said corresponding action button is selected, wherein the customized associated actions and the plurality of action buttons are accessible on a common navigation level.

### FIELD OF THE INVENTION

This invention relates to a graphical user interface (GUI) for a computing device. In particular, the invention relates to a method, apparatus and system to configure and access actions in the GUI.

### DESCRIPTION OF THE RELATED ART

Most computing devices today use GUIs for accessing software applications. Through consistent display screens, menus and toolbars, the GUIs have simplified the computing experience and have rendered technology in a user friendly manner. For instance, in portals and web applications, the GUIs provide multi-level navigation links, also referred to as “links.” In response to selection of a particular link, access may be provided to portal content and software applications. In addition, the links allow navigation from one portal content page to another.

Based upon a user profile, access to the portal content and software applications in the portal may be provided. The profile may include configuration settings, data and authorization information defining actions which the user is permitted to use. Therefore, the actions performed by the user differ according to the profile the user is associated with.

There may be cases where the user has authorization to perform a series of actions. For example, the profile associated with a sales manager role may include actions such as sales related services, self services and managerial services, which are accessible through the multi-level navigation links under different action buttons. The multi-level navigation links may include links in a hierarchical order providing access to the actions, which are related to a particular action button. In such a situation, the user may be required to navigate down multiple hierarchical levels to reach a desired navigation link that represents a desired action. For example, if the sales manager wants to access an action PAY SLIP OF THE MONTH under the action button SELF SERVICES, the sales manager may be required to navigate down two levels through the path SELF SERVICES/PAYROLL/PAY SLIP OF THE MONTH to access the PAY SLIP OF THE MONTH action. Similarly, if the sales manager accesses an action TRACK SALES ORDER regularly and if the action link is only available five navigation levels down, then the user may have to navigate down five levels to access the action TRACK SALES ORDER. This may result in a waste of time navigating and an unfriendly user experience. The sales manager may face similar problems as mentioned above when navigating up from a particular navigation level.

Although a user may be authorized to access portal content and software applications through the navigation links, there may be situations where the user only accesses only a few links regularly. In these circumstances, GUIs displaying a large number of navigation links are unnecessarily confusing and hard to navigate, especially on devices with limited display area. The problem is manifested in Wireless Application Protocol (WAP) cellular phones and Personal Digital Assistants (PDAs) where increasing the numbers of links may unnecessarily clutter the display area of the computing device, resulting in a reduced content area.

Typically, cellular phones and PDAs operate with limited bandwidth and therefore require significant time to download portal content. Consequently, when a user frequently traverses the same sequence of links in a series of web pages, the process of repeatedly downloading each page and locating and selecting links becomes tedious.

### SUMMARY OF THE INVENTION

An embodiment of the invention is directed to a method comprising associating at least one action with at least one of a plurality of action buttons; customizing associations of the associated actions; and including the customized associated actions corresponding to one of the plurality of action buttons in an expandable action menu when said corresponding action button is selected, wherein the customized associated actions and the plurality of action buttons are accessible on a common navigation level.

### BRIEF DESCRIPTION OF THE DRAWINGS

The embodiments of the invention, together with its advantages, may be best understood from the following detailed description taken in conjunction with the accompanying figures in which:

FIG. 1 illustrates a method to configure and access actions, according to one of the embodiments of the invention

FIG. 2 illustrates a method to configure and access actions, according to one of the embodiments of the invention

FIG. 3 illustrates a graphical user interface, according to one of the embodiments of the invention

FIG. 4 illustrates an action button and corresponding actions in an expandable action menu, according to one of the embodiments of the invention

FIG. 5 illustrates selecting one of the actions, according to one of the embodiments of the invention

FIG. 6 illustrates the graphical user interface when one of the actions is selected, according to one of the embodiments of the invention

FIG. 7 illustrates a plurality of action buttons in an expandable action button menu, according to one of the embodiments of the invention

FIG. 8 illustrates selecting one of the plurality of action buttons, according to one of the embodiments of the invention

FIG. 9 illustrates the graphical user interface when one of the action buttons is selected, according to one of the embodiments of the invention

FIG. 10 illustrates a system to configure and access actions, according to one of the embodiments of the invention

FIG. 11 illustrates an example of expandable action menu, according to one of the embodiments of the invention

FIG. 12 illustrates an example of expandable action menu displaying actions, according to an embodiment of the invention

FIG. 13 illustrates an example of selecting of one of the actions, according to an embodiment of the invention

FIG. 14 illustrates an example of displaying result of the selection, according to one of the embodiments of the invention

FIG. 15 illustrates another example of selecting one of the actions, according to one of the embodiments of the invention

FIG. 16 illustrates an example of displaying result of the selection, according to one of the embodiments of the invention

### DETAILED DESCRIPTION

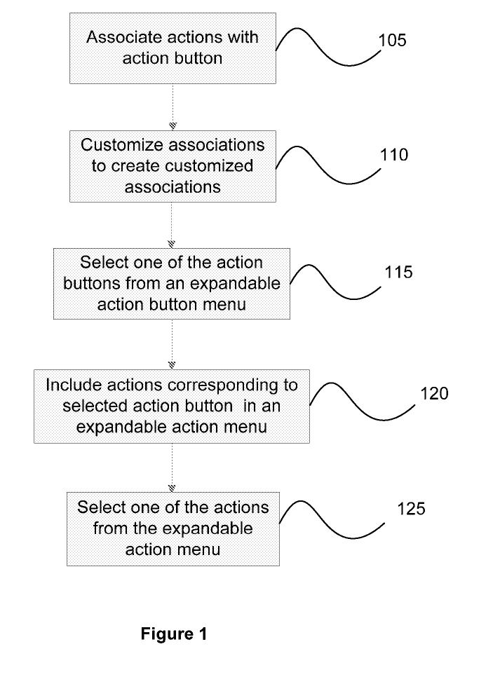

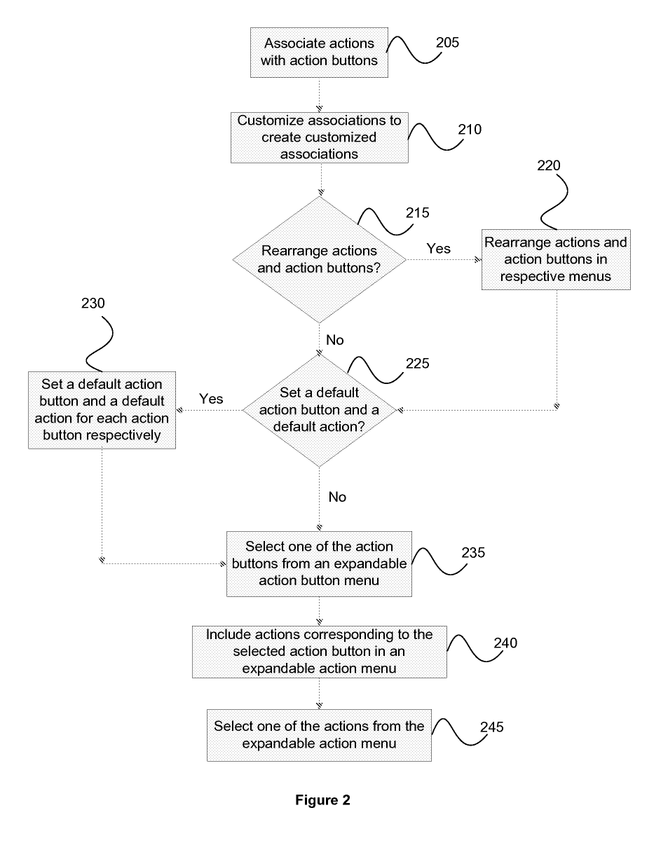

FIG. 1 and FIG. 2 illustrate different embodiments of a method for configuring and accessing action buttons and actions. Referring initially to FIG. 1, at 105, at least one action is associated with at least one of a plurality of action buttons. At 110, the association of the actions with the action buttons is customized. At 115, if one of the plurality of action buttons is selected, then, at 120 the customized actions corresponding to the selected action button are included in an expandable action menu. In one embodiment, the customized associated actions and the plurality of action buttons are accessible on a common navigation level i.e., within the same graphical window. At 125, the user may then select one of the actions from the expandable action menu.

In an embodiment of the invention, the action buttons may include but are not limited to multi-level navigation links to a portal and software application menus. Each action button provides access to actions which are associated with that particular action button. Similarly, the action may provide access to a software application, a software application menu option, a Uniform Resource Locator (URL) and multi-level navigation links of a portal.

The structure and delivery of portal content to the user is determined by role definitions based on the user's task within an organization (i.e., the user's “profile”). Based upon the profile, the actions are associated with a specific action button. For example, the profile associated with a sales manager role may have an action of CREATE INVOICE associated with action button INVOICE. Such associations are often made in a development environment where management of the portal content is defined at design time (i.e., prior to runtime).

In the development environment, conventional web or portal designing tools may be used for defining links which start at a source link and point to link target represented by a result of the actions. The portal designing tool may include an associating tool having a controller layer to define a hierarchy management to organize the portal content into logical categories by defining the structure of the content and to organize the content. The controller layer in the portal designing tool is also used when communicating with the user. According to variations in the role of the user, other associations may be provided for the user. Hence, all the actions available to the user are categorized under action buttons with different actions associated with each action button. For example, for a sales manager role, the profile may include a multi-level navigation link representing action button INOVICE. The action button INVOICE may include actions like CREATE INVOICE, TRACK INVOICE, EDIT INVIOCE, DELETE INVOICE, PAYMENT AWAITED. However, if the user has an additional role such as “Education & Training”, action buttons providing access to actions related to Education & Training may also be provided.

As mentioned above, the action buttons and the actions are made available to the user in an expandable action button menu 115, and expandable action menu 120, respectively. In one embodiment, selecting one of the action buttons in the expandable action button menu populates actions associated with the selected action button in the expandable action menu. The plurality of action buttons and associated actions corresponding to each action button in the expandable action button menu and the expandable action menu respectively are made available on a common navigation level. For instance in the above example, the sales manager accesses CREATE INOVICE action using navigation path . . . / . . . /INVOICE/CREATE INVOICE. This means that the action INVOICE is at different navigation level as the action button INVOICE. However, in one embodiment of the invention the action button and the action are provided on the common navigation level and accessible through the expandable action button menu and expandable action menu respectively. In case the action button and actions are arranged in a hierarchical order in the expandable action button menu and the expandable action menu, the expandable action button menu and the expandable action menu are on the common navigation level, thereby providing the action buttons and actions on the common navigation level.

As mentioned above, in one of the embodiments of the invention, the user may customize 110 the associations between the actions and action buttons. Moreover, in one embodiment, the customization is a function of user profile. Therefore, the customer may be allowed to customize associations, which are made accessible to the user as defined by the user profile. For example, the sales manager may not be able to customize Human Resource (HR) related actions if the profile associated with the user role does not allow access to HR actions. But, if the user has an additional role, the user may customize associations of the additional role.

In an embodiment of the invention, the expandable action menu and the expandable action button menu includes but is not limited to a right click, pop-up, drop down and expandable tree. Furthermore, the selection may include but is not limited to a button on a mouse, pressing a button on a stylus, pressing a key on a keyboard and speaking a voice command. The embodiments of the invention described herein employ drop downs for the expandable action button menu and the expandable action menu. However, a person skilled in the art may employ other possible menu types.

In addition, embodiments of the invention allow the user to create personalized action buttons and to associate actions with the personalized action buttons. The user may include actions, which are made accessible through multi-level navigation links of the portal. In addition, both related and unrelated actions may be associated with any of the action buttons. For example, CREATE INVOICE, TRACK INVOICE, EDIT INVIOCE, DELETE INVOICE and PAYMENT AWAITED are related actions categorized under one action button INVOICE. Unrelated actions may include actions which are often categorized under different categories. For example, for the sales manager role, actions under sales related services are unrelated with actions under self services. The user may also include external links like URLs in any of the action buttons.

In case the user intends to customize the association in the action buttons defined in the development environment or to customize personalized associations, the user may send an Extensible Markup Language (XML) request to the controller layer of the portal designing tool. If the user wants to associate only action 1 and action 2 to action button 1 and only action 5 to action button 2, the user may send the XML request, which may look like:

```
<user>
    <action button 1>
        <action 1>
        <action 2>
    <action button 2>
        <action 5>
<user>
```

Similarly, the user may customize the action buttons and include or exclude action buttons from the expandable action button menu. The controller layer of the portal designing tool may check authorization of the user and, based on the authenticity of the authorization, may allow customization of the associations. The user may send the request as a single request for more than one action button with customized associated actions for each such action button. The user may also send such XML requests individually for each action button. Returning to the above example, the sales manager may customize associations by only associating the actions CREATE INVOICE and EDIT INVOICE with corresponding action button INVOICE. In a similar manner, a software application menu may be included as one of the actions buttons and a software application menu option as associated actions. For example, action button FORMAT may include PARAGRAPH, THEME, AUTOFORMAT, TABS and BORDERS AND SHADING as associated actions.

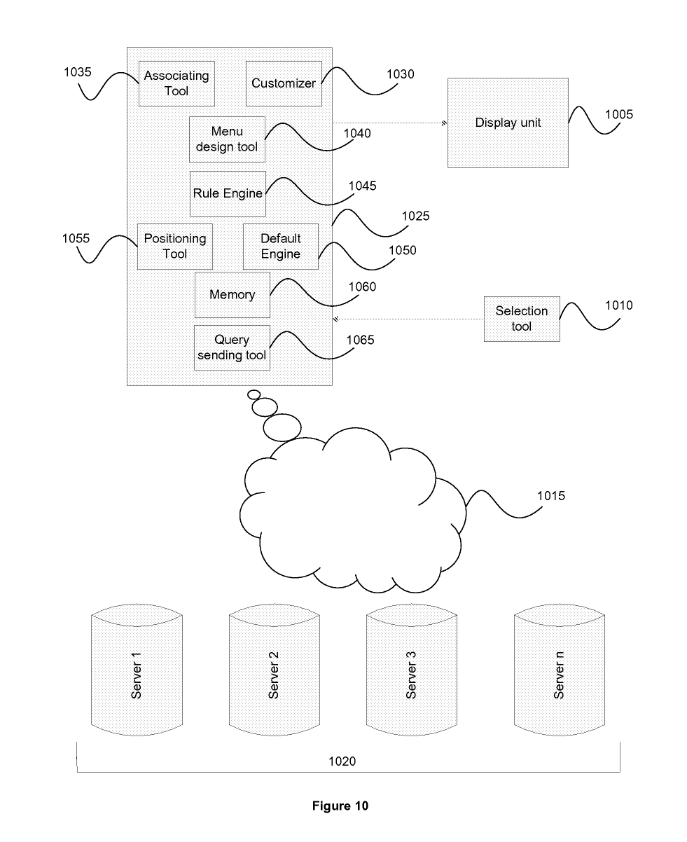

FIG. 2 illustrates additional details of one embodiment of the invention. At 215, a determination is made as to whether the user wishes to rearrange actions and action buttons. If so, then at 220, based on user input, actions are rearranged in the expandable action menu and action buttons are rearranged in the expandable action button menu. The actions and action buttons may be arranged either manually or automatically. If the actions and action buttons are arranged manually, a positioning tool 1055, illustrated in FIG. 10 prompts the user to rearrange actions and action buttons. To do so, in one embodiment, the user drags and drop the action buttons and actions in the expandable action button menu and expandable action menu respectively. Other manual operations are also possible for rearranging the action buttons and actions in respective expandable menus. For example, rearranging a particular action in the expandable action menu may include moving the action using designated move up and move down buttons which are communicatively linked with the positioning tool.

Turning again to FIG. 1, at 225 a determination is made as to whether a default action button in the expandable action button menu and a default action corresponding to each action button in expandable action menu is to be set. If so, then at 230, based on user input, default action is set in the expandable action menu and default action button is set in the expandable action button menu. In one embodiment, this is accomplished via a default engine 1050 illustrated in FIG. 10. The default action button and action associated with each action button may be set as default either manually or automatically. If the default actions and action buttons are set manually, the default engine prompts the user to specify the default actions and action buttons. To manually set the default action button and default action, the user may send an XML request to the controller layer of the portal designing tool (see, e.g., the XML example provided above).

In another embodiment of the invention, a set of rules may be defined for automatically setting one of the plurality of action buttons as a default action button and setting one of the customized associated actions as a default action. Similarly, rules may be defined for automatically arranging the action buttons in the expandable action button menu and the customized associated actions in the expandable action menu. Each rule many either be defined in the development environment by an administrator using a rule engine or the user may set the rule by sending an XML request to the controller layer of the portal designing tool using a rule engine 1045 as illustrated in FIG. 10. For example, a rule may specify that the action button which is accessed the most number of times relative to other action buttons becomes the default action button. Similarly, another rule may specify that the action which is accessed the most number of times via each action button becomes the default action for that particular action button. In case of URLs, persistent cookies may be used to compute the number of times the URL is accessed. Another rule may be included to set the most recently accessed action button and the most recently accessed action in each action button as the default action button and the default action, respectively. In addition, in one embodiment, based on change of usage of the default action button and the default action, the positioning of the default action button and default action may be changed in the respective expandable menus.

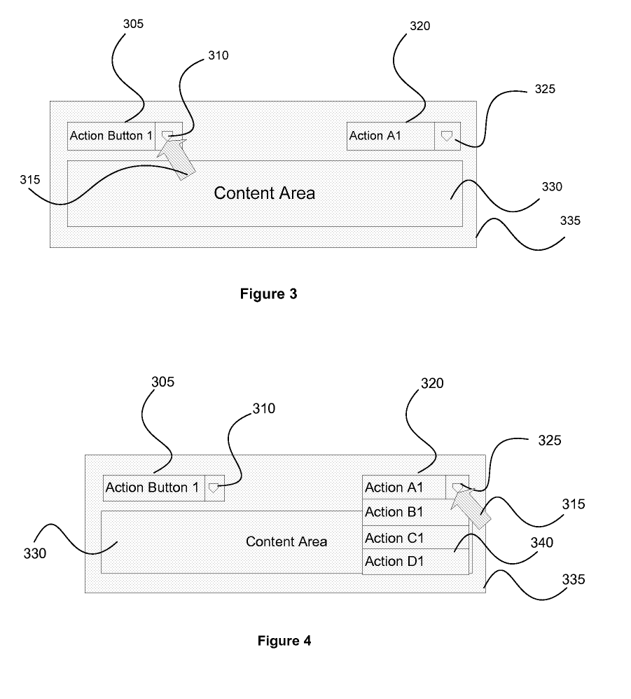

A graphical user interface (GUI) employed in one embodiment of the invention is illustrated in FIG. 3 through FIG. 9. In these figures, the default action button is the action button which is displayed when the expandable action button menu is in unexpanded form. Similarly, when an action button is selected, the default action for the selected action button is displayed when the expandable action menu is in unexpanded form. Turning to FIG. 3, the GUI is shown within in a display area 335 according to one of the embodiments of the invention. The GUI shows the expandable action button menu 305 with an action button agent 310 for expanding the expandable action button menu. The GUI further shows the expandable action menu 320 with an action agent 325 for expanding the expandable action menu. The GUI further includes a selection tool 315 and content area 330. More specifically, in FIG. 3 Action Button 1 and one of associated actions Action A1 are shown.

FIG. 4 shows list of actions 340 associated with the Action Button 1 by expanding the expandable action menu 320 through the action agent 325 using the selection tool 315.

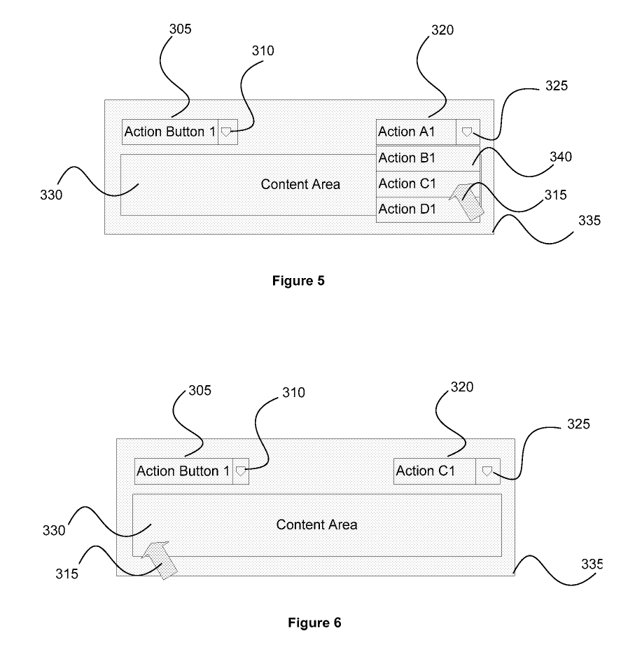

FIG. 5 shows selecting one of the actions Action C1 from the list of actions 340 as shown in the expandable action menu 320 using the selection tool 315.

FIG. 6 shows the graphical user interface when the Action C1 corresponding to the Action Button 1 is selected from the expandable action menu 320. If the rule associated with default setting of the action includes making the latest accessed action as the default action, then Action C1 will become the default action for action button Action button 1.

FIG. 7 shows a GUI in the display screen 335 according to one of the embodiments of the invention. The GUI shows the expandable action button menu 305 with the action button agent 310 for expanding the expandable action button menu 345. The GUI further shows the expandable action button menu with a selection tool 315 to select one of the plurality of action buttons.

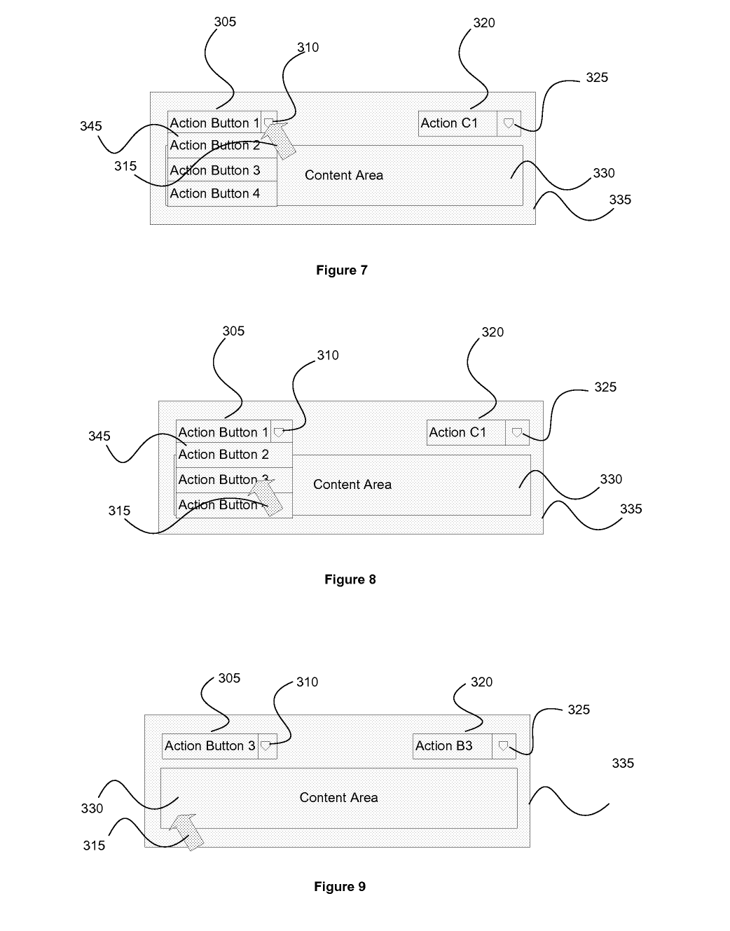

In FIG. 8, Action Button 3 is selected from the plurality of Action Buttons 345 in the expandable action button menu 305 using the selection tool 315.

FIG. 9 shows the GUI when Actions Button 3 is selected from the plurality of action buttons. If the rule associated with default setting of the action button includes making the latest accessed action button as the default action, then Action Button 3 will become the default action button. There is a corresponding change in the Action list based on the Action button selected and default action Action B3 from the corresponding Action list is displayed in the expandable action menu.

FIG. 10 shows one embodiment of a system to configure and access actions which includes an associating tool 1035 used to associate at least one action with at least one of a plurality of action buttons in the development environment. A customizer 1030 receives the XML request from the user and customizes associations by providing customizing instructions to the associating tool. The customizer customizes associations created in the development environment and associations related to personalized action buttons. The customizer includes the customized associated actions corresponding to one of the plurality of action buttons in an expandable action menu when the corresponding action button is selected. The system is communicatively connected to a display unit 1005 on which GUI is rendered.

In other embodiment of the invention, the system includes a menu design tool 1040 to design display layout of the expandable action button menu and the expandable action menu. A positioning tool 1055 is also provided to arrange the action buttons in the expandable action button menu and the customized associated actions in the expandable action menu, respectively, either manually or automatically. The positioning tool is communicatively connected to the menu design tool to send positioning instructions to the menu design tool. If the positioning is manual, the positioning tool will receive an XML request from the user and transmit the XML request to the design menu tool to reposition the action buttons and actions. A default engine 1050 is also provided to set one of the plurality of actions buttons and one of the actions in each default button as default action button and default action respectively. The default engine is communicatively connected to the associating tool to send default setting instructions to the associating tool. A rule engine 1045 is associated with the positioning tool, the menu design tool and the default engine to automate the positioning and default setting based on the rules associated with the default engine. A memory 1060 is also provided to store related information, which includes the associations, the customized associations and the rules.

The system also includes a selection tool 1010 to select one of the plurality of action buttons from the expandable action button menu. Similarly, the same selection tool may be used to select one of the actions corresponding to the selected action button from the expandable action menu and sends a query. The selection tool is associated with a query sending tool 1065 to send a query in form of Hyper Text Transfer Protocol (HTTP) requests to servers 1020 based upon the selection of the customized associated action to output results. The transmission of the query may take place over a communication network 1015 such as wired or wireless communication medium.

In one of the embodiments, the system includes a memory for storing program code and a processor for processing the program code to generate the GUI, the GUI comprising a default action which, when selected, causes execution of a default action; an action button positioned adjacent to the default action; and a drop-down default action menu displayed upon selection of the default action button, the drop-down default action menu comprised of a plurality of action entries, each action entry corresponding to a user-selectable action; wherein, upon selection from the drop-down default action menu, the selected action entry becomes associated with the default action. The default action and the action button may be selected from a contextual and a graphical button.

Those of ordinary skill in the art will appreciate that the hardware on which the embodiments of the invention are practiced may vary depending on the implementation. Other internal hardware or peripheral devices, such as flash ROM (or equivalent nonvolatile memory) or optical disk drives and the like, may be used in addition to, or in place of the hardware described above. Also, the processes of the invention may be applied to a multiprocessor data processing system.

In one embodiment, the result corresponding to the selection of an action is retrieved from the servers and displayed on the display unit 1005. The result may include a software application, a result of one of the option menus of the software application, a URL and an intermediate result. The intermediate result includes a result wherein entries in a few of the fields are entered by the system based on the selection by the user. One such intermediate result is shown in FIG. 14.

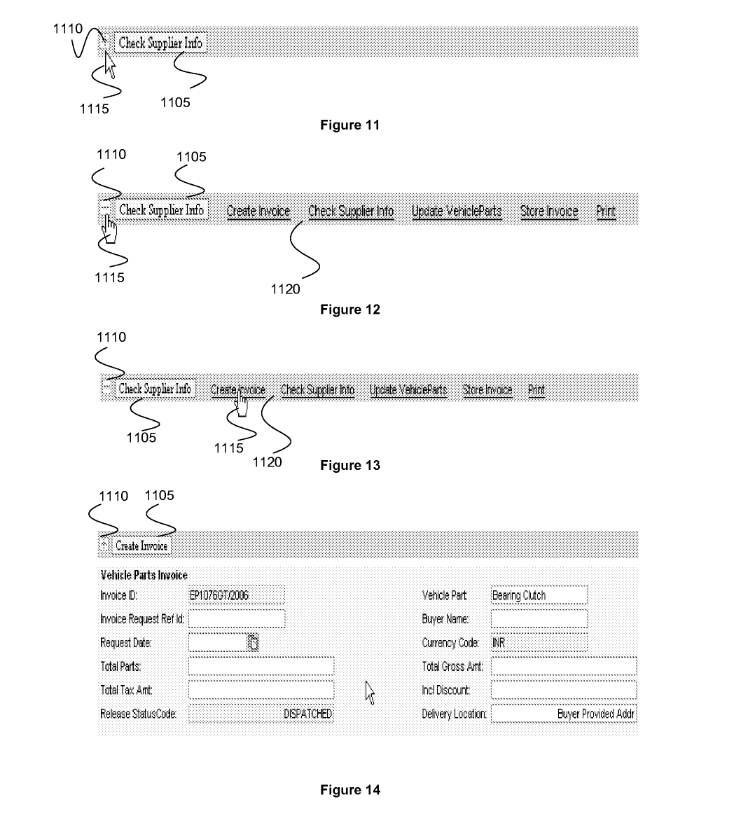

FIG. 14 can be better understood within the context of FIG. 11 and FIG. 12. FIG. 11 shows Check Supplier Info as one of the actions which the user may select using the selection tool 1115 through an expandable action menu 1105. In case the user intends to select a different action, the user may expand the expandable action menu using an agent 1110 and the selection tool (as shown in FIG. 12) to show list of actions 1120. Using the selection tool, one of the actions may be selected. For example, CREATE INVOICE is chosen in FIG. 13.

Based upon the selection from the expandable action menu, a query is send to the servers, over the network to output results as show in FIG. 14. The result in FIG. 14 shows the intermediate result. For one of the embodiments, the intermediate result includes an invoice creation form, wherein a few of the entries like INVOICE ID, VEHICLE PART, CURRENCY CODE, RELEASE STATUS CODE AND DELIVERY LOCATION are entered by the system automatically based on the selection button of the user. In such a case, the user only needs to fill in entries in the other fields.

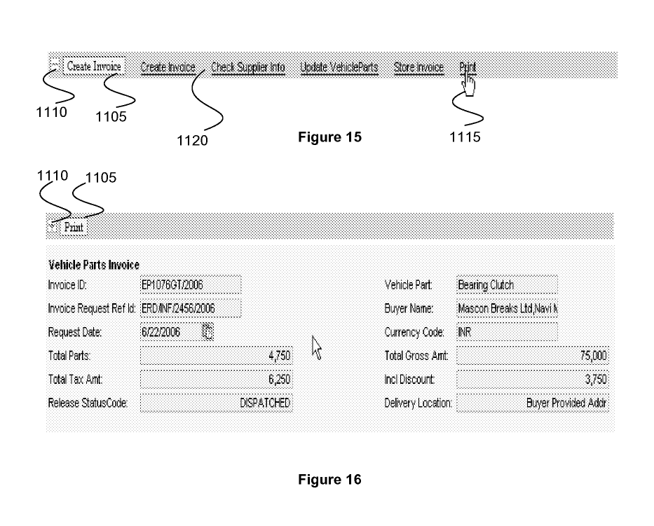

In another example, as shown in FIG. 15, selection of the PRINT action from the list of actions renders a print preview as an intermediary result as shown in FIG. 16. In case the user intends to print the command, the PRINT action may be selected to print the print preview result.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method comprising:
associating at least one action with at least one of a plurality of action buttons;
customizing associations of the associated actions; and
including the customized associated actions corresponding to one of the plurality of action buttons in an expandable action menu when said corresponding action button is selected, wherein the customized associated actions and the plurality of action buttons are accessible on a common navigation level.

2. The method of claim 1, further comprising displaying the plurality of action buttons in an expandable action button menu.

3. The method of claim 1, wherein the action button is selected from a group consisting of multi-level navigation links of a portal and software application menu.

4. The method of claim 1, wherein the action is selected from a group consisting of a software application, a software application menu option, a Uniform Resource Locator (URL) and multi-level navigation links of a portal.

5. The method of claim 1, further comprising selecting one of the customized associated actions from the expandable action menu, wherein selecting one of the customized associated actions sends a query to servers, over a network, based upon the selection to output results.

6. The method of claim 1, further comprising:
setting one of the plurality of action buttons as a default action button;
setting one of the customized associated actions in each of the plurality of action button as a default action; and
arranging the action buttons in the expandable action button menu and the customized associated actions in the expandable action menu respectively.

7. The method of claim 6, wherein the setting and arranging is selected from a group of automatic and manual operation.

8. The method of claim 7, further comprising defining a set of rules for automatically setting and arranging.

9. The method of claim 1, wherein the customized associated actions is selected from a group consisting of related and unrelated actions.

10. The method of claim 1, wherein the expandable action menu and the expandable action button menu is selected from a group consisting of a right click, a pop-up, a drop down and an expandable tree.

11. The method of claim 1, wherein the selection is selected from a group consisting of pressing of a button on a mouse, pressing a button on a stylus, pressing a key on a keyboard and speaking a voice command.

12. The method of claim 5, wherein the selection is selected from a group consisting of pressing of a button on a mouse, pressing a button on a stylus, pressing a key on a keyboard and speaking a voice command.

13. An article of manufacture, comprising:
a machine readable medium that provides instructions, which when executed by a machine, causes the machine to:
associate at least one action with at least one of a plurality of action buttons;
customize associations of the associated actions; and
include the customized associated actions corresponding to one of the plurality of action buttons in an expandable action menu when said corresponding action button is selected, wherein the customized associated actions and the plurality of action buttons are accessible on a common navigation level.

14. The medium of claim 13, wherein the machine readable medium provides instructions, which when executed by a machine, causes the machine to display the plurality of action buttons in an expandable action button menu.

15. The medium of claim 13, wherein the machine readable medium provides instructions, which when executed by a machine, causes the machine to select the action button from a group consisting of multi-level navigation links of a portal and software application menu.

16. The medium of claim 13, wherein the machine readable medium provides instructions, which when executed by a machine, causes the machine to select the action from a group consisting of a software application, a software application menu option, a Uniform Resource Locator (URL) and multi-level navigation links of a portal.

17. The medium of claim 13, wherein the machine readable medium provides instructions, which when executed by a machine, causes the machine to select one of the customized associated actions from the expandable action menu.

18. The medium of claim 13, wherein the machine readable medium provides instructions, which when executed by a machine, causes the machine to:
set one of the plurality of action buttons as a default action button;
set one of the customized associated actions in each of the plurality of action button as a default action; and
arrange the action buttons in the expandable action button menu and the customized associated actions in the expandable action menu respectively.

19. The medium of claim 18, wherein the machine readable medium provides instructions, which when executed by a machine, causes the machine to define a set of rules for automatic setting and arrangement.

20. The medium of claim 13, wherein the machine readable medium provides instructions, which when executed by a machine, causes the machine to select the customized associated actions from a group consisting of related and unrelated actions.

21. The medium of claim 13, wherein the machine readable medium provides instructions, which when executed by a machine, causes the machine to select the expandable action menu and the expandable action button menu from a group consisting of a right click, a pop-up, a drop down and an expandable tree.

22. A system comprising:
an associating tool to associate at least one action with at least one of a plurality of action buttons;
a customizer to customize associations of the associated actions; and
the customizer to include the customized associated actions corresponding to one of the plurality of action buttons in an expandable action menu when said corresponding action button is selected, wherein the customized associated actions and the plurality of action buttons are accessible on a common navigation level.

23. The system of claim 22, further comprising:
a memory to store associations and customized associations between actions and plurality of action buttons;
a menu design tool to arrange the customized associated actions and plurality of action buttons in an expandable action menu and expandable action button menu respectively;
a selection tool to select one of the plurality of action buttons and one of the actions corresponding to the selected action button; and
a query sending tool to send a query to servers, over a network, based upon the selection of the customized associated action to output results.

24. The system of claim 22, further comprising a default engine to set one of the plurality of actions buttons and one of the actions as default action button and default action respectively.

25. The system of claim 22, further comprising a positioning tool to arrange the action buttons in the expandable action button menu and the customized associated actions in the expandable action menu respectively.

26. The system of claim 22, further comprising a rule engine in association with: the default engine to automatically set one of the plurality of actions buttons and one of the actions as default action button and default action respectively; and the positioning tool to automatically arrange the action buttons in the expandable action button menu and the customized associated actions in the expandable action menu respectively.

27. The system of claim 22, wherein the customized associated action is selected from a group consisting of related and unrelated actions.
